(19) United States
(12) Patent Application Publication
(10) Pub. No.: US 2021/0357097 A1
(43) Pub. Date: Nov. 18, 2021

(54) SINGLE BUTTON OS FOR MOBILE TOUCH SCREEN DEVICES

(71) Applicant: Spartive, LLC., Atlanta, GA (US)

(72) Inventor: Jason Parker, Atlanta, GA (US)

(21) Appl. No.: 15/930,878

(22) Filed: May 13, 2020

(51) Int. Cl. G06F 3/0481; G06F 3/0484; G06F 3/0482

(52) U.S. Cl. CPC G06F 3/04812; G06F 3/04817; G06F 3/04883; G06F 3/0482; G06F 3/04847

(57) ABSTRACT

A system and method for providing a Single Button OS for Mobile Touch Screen Devices is disclosed. The system includes a center input element on a touch screen device, the center input element selects a user input interface when a user touches the center input element a user touch point, a first plurality of navigational links arranged in a first ring around the center input element, one of the first plurality of navigational links are selected when the user moves the user touch point from the center input element to the first ring, and a second plurality of navigational links arranged in a second ring around the center input element and the first ring, one of the second plurality of navigational links are selected when the user moves the user touch point from the first ring to the second ring. The selected navigational element is depressed while the user touch point in located on one of the navigational links causing the user interface to activate the navigational link and exposing corresponding page content associated with the selected navigational element.

### TECHNICAL FIELD

This application relates in general a system and method for providing touch based user interface, and more specifically, to a system and method for providing a Single Button OS for Mobile Touch Screen Devices according to the present invention.

### BACKGROUND

Many mobile devices such a smartphones and tablets are held in a user's hand while operating devices to accomplish tasks. This situation arises routinely when users are using smartphones while traveling on trains and mass transit, walking between locations, or simply standing while awaiting events to occur. Use of these devices while the user is doing other tasks at the same time, typically requires the user to both hold the device and interact with its user interface to select content, applications, functions, and tasks to be performed. Users attempt to use one or two fingers while holding the device in the same hand to accomplish these acts.

Current mobile device operating systems (OSs) do not support easy use of their interface elements by just one finger as these devices continue to use a screen architecture used in larger computing devices in which a user interacts with the device with a keyboard, pointing device and a larger screen. This type of interaction is quite different than a user of a mobile device attempting to use just one finger while attempting to hold the device in the same hand.

Therefore, a need exists for a mobile device and its operating system to provide touch based user interface that provides a Single Button OS for Mobile Touch Screen Devices. Such a user interface would make the devices easier to use while holding the mobile device while the user is on the go.

### SUMMARY

In accordance with the present invention, the above and other problems are solved by providing a system and method for a Single Button OS for Mobile Touch Screen Devices according to the principles and example embodiments disclosed herein.

In one embodiment, the present invention is a system for a Single Button OS for Mobile Touch Screen Devices. The system includes a center input element on a touch screen device, the center input element selects a user input interface when a user touches the center input element a user touch point, a first plurality of navigational links arranged in a first ring around the center input element, one of the first plurality of navigational links are selected when the user moves the user touch point from the center input element to the first ring, and a second plurality of navigational links arranged in a second ring around the center input element and the first ring, one of the second plurality of navigational links are selected when the user moves the user touch point from the first ring to the second ring. The selected navigational element is depressed while the user touch point in located on one of the navigational links causing the user interface to activate the navigational link and exposing corresponding page content associated with the selected navigational element.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides ??? according to the present invention.

FIG. 2 illustrates a first set of operations within an example embodiment of a one button mobile OS user interface according to the present invention.

FIG. 3 illustrates a second set of operations within an example embodiment of a one button mobile OS user interface according to the present invention.

FIG. 4 illustrates a third set of operations within an example embodiment of a one button mobile OS user interface according to the present invention.

FIG. 5 illustrates a fourth set of operations within an example embodiment of a one button mobile OS user interface according to the present invention.

FIG. 6 illustrates a generalized schematic of a programmable processing system utilized as the various computing components described herein used to implement an embodiment of the present invention.

### DETAILED DESCRIPTION

This application relates in general a system and method for providing touch based user interface, and more specifically, to a system and method for providing Single Button OS for Mobile Touch Screen Devices according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The term “user” refer to an entity, e.g. a human, using the Single Button OS for Mobile Touch Screen Devices including any software or smart device application(s) associated with the invention. The term user herein refers to one or more users.

The term “invention” or “present invention” refers to the invention being applied for via the patent application with the title “SINGLE BUTTON OS FOR MOBILE TOUCH SCREEN DEVICE.” Invention may be used interchangeably with One Button OS.

The terms “communicate”, or “communication” refer to any component(s) connecting with any other component(s) in any combination for the purpose of the connected components to communicate and/or transfer data to and from any components and/or control any settings,

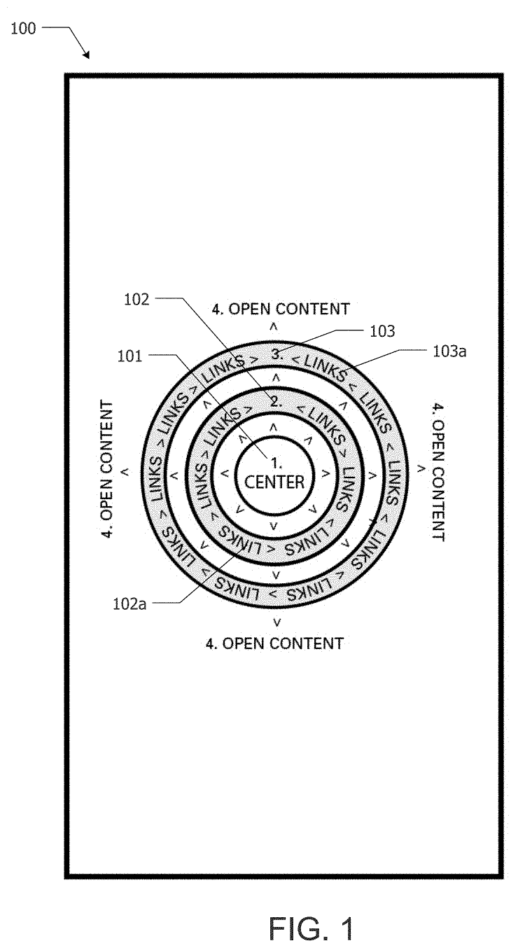

In general, the present disclosure relates a system and method for providing a touch screen-based user interface to a mobile device according to the present invention. To better understand the present invention, FIG. 1 illustrates an example embodiment for a one button mobile OS control 100 for providing a touch-screen based user interface to a mobile device according to the present invention. A touch screen from a mobile device such as a smartphone, tablet, or similar device is shown having a one button mobile operating system (OS) user interface as a user may encounter one.

A user will use a thumb or finger to slide a center input element or button 101 in any direction to expose navigational elements. As the user moves a finger away from the center 101, the user encounters a navigational link 102a that is part of a first ring 102 of links. As the user moves the finger in a particular direction, the navigation elements 102a-n rotate left and right in a circular pattern in front of the finger to arrive at a desired link. Time and/or pressure from the finger while located on top of a link 102a will expose additional content in a second ring of links 103 in that particular direction once a navigation element 102a is chosen.

The user may move to links 103a on this second ring of links 103 to select another link to select and navigate. These links 103a may correspond to areas with sub navigation that perform in the same manner until a link is directed towards a page having content. When this final link is selected, the final link is activated, and page content is exposed to the user on the touch screen.

While two levels of links 102-103 are shown in FIG. 1, one of ordinary skill in the art will recognize that any number of levels of nested links, similar to pop-up. context sensitive menus are used in computing systems that may use menus and a pointing device such as a mouse, trackball, or trackpad to accept inputs from a user. Also the number of links in a particular ring of links may present multiple links of any number using the interface of the present invention as disclosed herein.

The links 103a that may lead to content may point to pages to be presented within a web browser where the nested rings of links of FIG. 1 presents a set of browser bookmarked pages that a user wishes to visit. The links 103 may also lead to application or functions present on the mobile device that the user wants to activate or bring forward to present its content on the touch screen for use by the user. The links 103 may represent functions within an application similar to drop down function menus used in desktop applications. The end link causes an operation to be initiated that performs a task selected by the user. The use of the user interface construct may be adapted to these any other similar uses as defined by the smartphone, an application, or an interface.

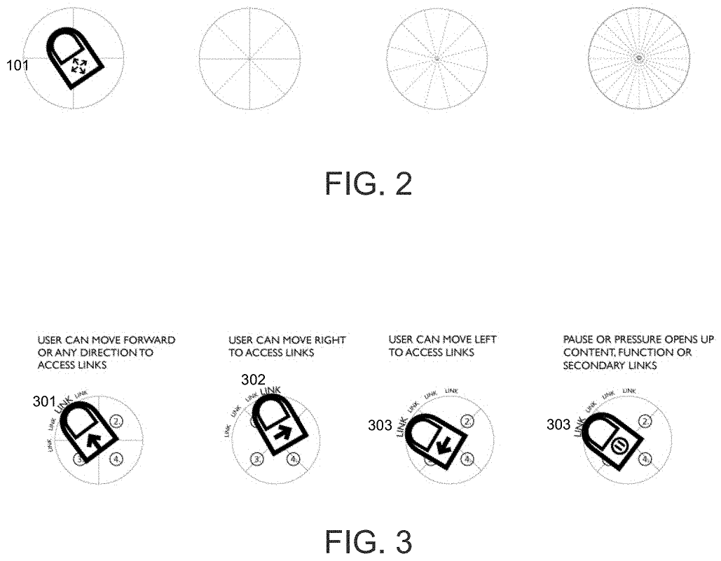

FIG. 2 illustrates a first set of operations within an example embodiment of a one button mobile OS user interface according to the present invention. The user begins by placing a finger onto a center 101 of the user interface 100. The user is presented options for amount of navigation directions 101 can be added and expanded based on user intentions. Navigation is static until the user moves into any direction. One touch in the center 101 of a blank touch screen exposes function of the home navigation.

FIG. 3 illustrates a second set of operations within an example embodiment of a one button mobile OS user interface according to the present invention.

A user moving a finger in any direction 301 will expose links 302 in the preset area direction. A user may move forward into secondary links or functions. Users may move right 302 to access links. Pause or pressure by the user's finger on the desired link 303 will open the selected link to the referenced content, function, or secondary navigation ring.

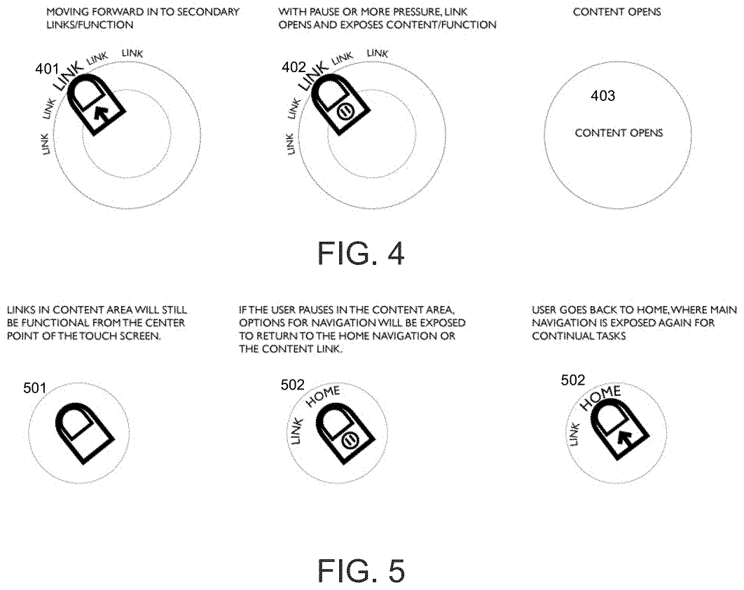

FIG. 4 illustrates a third set of operations within an example embodiment of a one button mobile OS user interface according to the present invention. Secondary links 103a present themselves in the same manner once first level 102 navigation is accessed. Secondary links 103a are exposed based on the link chosen content or function will open. The user moving a finger forward 401 into secondary links/function will select links in the manner of the first ring 102 of links. A user presenting a pause or more pressure on a selected secondary link 402 causes the link to open and exposes content or function. When a selected link points to content, the content opens 403.

FIG. 5 illustrates a fourth set of operations within an example embodiment of a one button mobile OS user interface according to the present invention. To access the home state of the center point navigation 101, the user will return to center of screen 100 while pausing operations being executed and causing functions to be exposed 501. Links 502 in content area will still be functional from the center point of the touch screen. If the user pauses in the content area 501, options for navigation will be exposed to return to the home navigation 501 or the content link 502. User goes back to home when home link 501 is selected. At home, main navigation is exposed again for continual tasks.

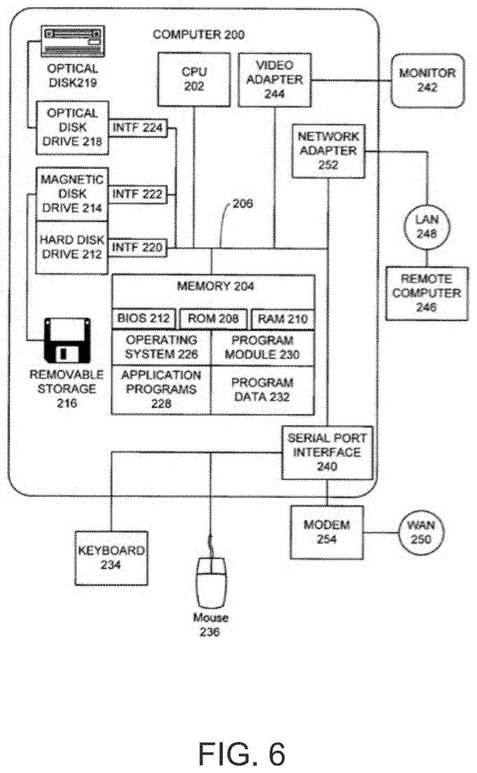

FIG. 6 illustrates a generalized schematic of a programmable processing system utilized as the various computing components described herein used to implement an embodiment of the present invention. The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RANI (SDRAM), or the like. The computer system 200 may utilize RANI 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of a mobile operating system, including servers, personal computers, and mobile devices as shown in FIG. 1. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

1. A system for providing a single button operating system for mobile touch screen devices, the system comprising:
a center input element on a touch screen device, the center input element selects a user input interface when a user touches the center input element with a user touch point;
a first plurality of navigational links arranged in a first ring, having a plurali of positions around the first ring, being configured to appear around the center input element when the user touch point moves from the center input element in any direction, one of the first plurality of navigational links is selected when the user moves the user touch point from the center input element to a first position of the first ring, the one of the first plurality of navigational links is unselected when the user touch point moves from the first position of the first ring, and a second one of the first plurality of navigational links is selected when the user touch point moves to a second position of the first ring, the first position and the second position of the first ring are adjacent to each other; and
wherein the selected navigational element is depressed while the user touch point is located on one of the navigational links causing the user interface to activate the navigational link and exposing corresponding page content associated with the selected navigational link.

2. The system according to claim 1, wherein a home navigational link appears within one of the plurality of positions around the first ring when the user touch point pauses within the one of the plurality of positions around the first ring, depressing the home navigational link returns the user touch point to the center input element and hides the first ring on the touch screen device.

3. The system according to claim 2, wherein the system further comprises a second plurality of navigational links arranged in a second ring around the center input element and the first ring, the second ring appears when the user touch point is within the first ring and is moved outward from the center input element and outside the first ring, and one of the second plurality of navigational links is selected when the user moves the user touch point from the first ring to the one of the second plurality of navigational links of the second ring.

4. The system according to claim 3, wherein moving the user touch point around the second ring selects a navigational link corresponding to the user touch point.

5. The system according to claim 4, wherein the user raising the user touch point off of the touch screen device causes the the center input element to deactivate any selected navigational elements.

6. The system according to claim 4, wherein the touch screen device comprises a smartphone, a tablet, an input panel to an appliance, and an input panel to an application.

7. The system according to claim 1, wherein exposing corresponding page content associated with the selected navigational link causes a separate application to be enabled to operate.

8. The system according to claim 7, wherein the exposing corresponding page content associated with the selected navigational link causes a function to be performed.
